(19) United States
(12) Patent Application Publication
(10) Pub. No.: US 2005/0001008 A1
(43) Pub. Date: Jan. 6, 2005

(54) Electric nailing gun

(75) Inventor: Pei-Chang Sun, Taichung (TW)

Correspondence Address: BACON & THOMAS, PLLC, 625 SLATERS LANE, FOURTH FLOOR, ALEXANDRIA, VA, 22314, US

(73) Assignees: Pei-Chung Sun, TAICHUNG (TW); MODERN PIONEER LTD., TAICHUNG CITY (TW)

(21) Appl. No.: 10/636,605

(22) Filed: Aug. 8, 2003

(30) Foreign Application Priority Data
Jul. 4, 2003 (CN) 03265400.6

(51) Int. Cl. B25C 5/06

(52) U.S. Cl. 227/131

(57) ABSTRACT

An electric nailing gun in which a piston head is reciprocated with a nailing plunger in a receiving chamber of a cylinder to force air out of the receiving chamber of the cylinder toward a coil of a nail driving mechanism for dissipating heat, which is generated by the coil, during down stroke of the nailing plunger, and to buffer the returning speed of the nailing plunger by compressing air, which exists between the piston head and the receiving chamber of the cylinder, during return stroke of the nailing plunger after each nailing action.

### BACKGROUND OF THE INVENTION

1. Field of the Invention

The present invention relates generally to an electric nailing gun and, more particularly to such an electric nailing gun, which provides good plunger buffering and heat dissipation effects.

2. Description of the Related Art

In a conventional electric nailing gun, electricity is connected to a coil to produce a magnetic field, causing a plunger to move rapidly to the barrel and to achieve a nailing action. When electricity disconnected from the coil, the plunger is pushed back to its former standby position by a spring. However, the rapid return stroke of the plunger after each nailing action upon disconnection of electricity from the coil causes the plunger to strike the housing of the electric nailing gun directly, thereby causing damage to the housing or displacement of the plunger. Shock absorbing blocks may be mounted inside the housing of the electric nailing gun to absorb shocks upon each return stroke of the plunger. However, the shock absorbing blocks wear quickly with use, and may fall out of place upon striking of the plunger. When a shock absorbing block fell out of place, the fallen shock absorbing block may interfere with the action of the plunger.

Further, during a continuous nailing operation, the coil releases much heat, increasing the inside temperature of the housing. Conventional electric nailing gun designs provide no measure to dissipate heat from the housing.

### SUMMARY OF THE INVENTION

The present invention has been accomplished under the circumstances in view. It is the main object of the present invention to provide an electric nailing gun, which buffers the return stroke of the plunger by means of regulating the flow of air.

It is another object of the present invention to provide an electric nailing gun, which dissipates heat from the coil during nailing operation.

To achieve these objects of the present invention, the electric nailing gun comprises a housing having a receiving chamber; a barrel located on a front side of the housing; a nail magazine connected between the barrel and the housing; a nail driving mechanism mounted inside the housing and having a fixed coil holder provided with an axially extended center through hole, a plunger slidably mounted in the axially extended center through hole of the coil holder and movable between a standby position and a nailing position, spring means supporting the plunger in the standby position, and a coil wound round the coil holder and adapted to cause the plunger to move from the standby position to the nailing position when electrically connected; and a piston head located on a top side of the plunger for synchronous motion. The piston head has an outer diameter smaller than a diameter of the receiving chamber of the housing and greater than an outer diameter of the plunger. The piston head is adapted to force air below toward the coil during a forward stroke of the plunger from the standby position to the nailing position, and to compress air above and to further buffer returning speed of the plunger during a return stroke of the plunger from the nailing position to the standby position.

### BRIEF DESCRIPTION OF THE DRAWINGS

FIG. 1 is an exploded view of an electric nailing gun according to a first preferred embodiment of the present invention.

FIG. 2 is a sectional assembly view of the electric nailing gun according to the first preferred embodiment of the present invention.

FIG. 3 is a sectional view of the coil holder for the electric nailing gun according to the first preferred embodiment of the present invention.

FIG. 4 is a sectional view of the disk member for the electric nailing gun according to the first preferred embodiment of the present invention.

FIG. 5 is a top view of the friction ring for the electric nailing gun according to the first preferred embodiment of the present invention.

FIG. 6 is a sectional view taken along line 6-6 of FIG. 5.

FIG. 7 is a sectional view of the cylinder for the electric nailing gun according to the first preferred embodiment of the present invention.

FIG. 8 is a sectional view of the valve flap for the electric nailing gun according to the first preferred embodiment of the present invention.

FIG. 9 is an enlarged view of a part of FIG. 2, showing the plunger in the standby position.

FIG. 10 is similar to FIG. 9 but showing the plunger moved to the nailing position.

FIG. 11 is an exploded view of an electric nailing gun according to a second preferred embodiment of the present invention.

### DETAILED DESCRIPTION OF THE INVENTION

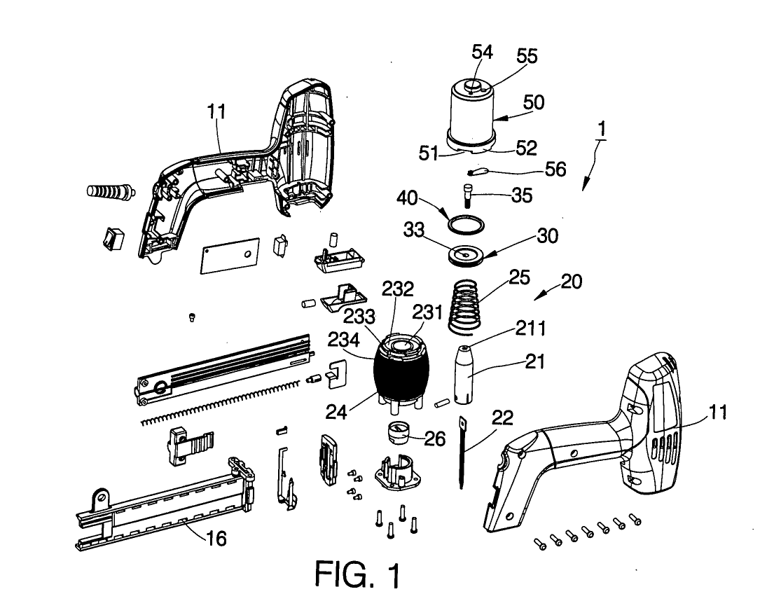

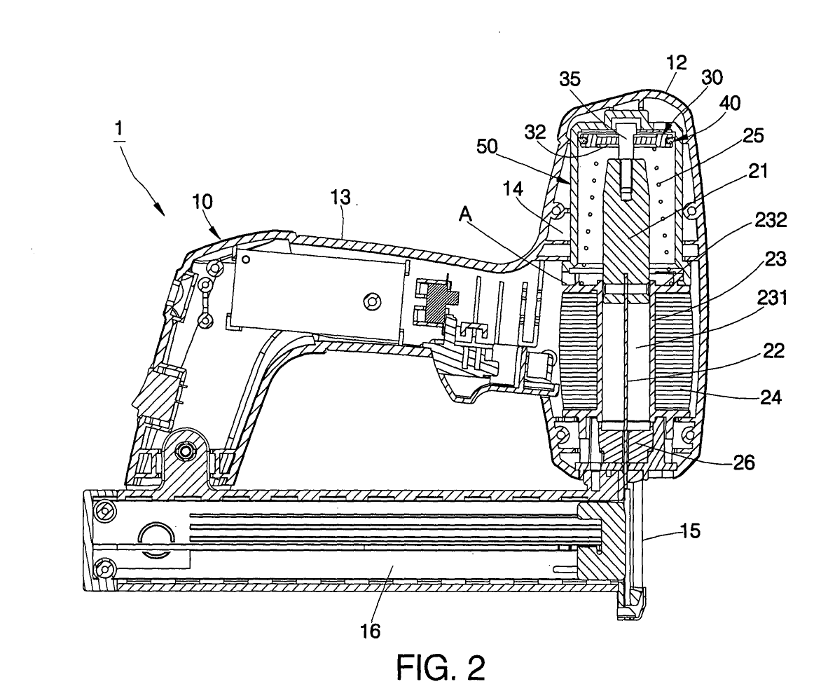

Referring to FIGS. 1 and 2, an electric nailing gun 1 is shown comprised of a gun body, a nail driving mechanism 20, a piston head comprised of a disk member 30 and a friction ring 40, and a cylinder 50.

The aforesaid gun body is comprised of a housing 10 formed of two symmetrical half shells 11, the housing having a head 12, a handle 13, and a receiving chamber 14 defined in the head 12, a barrel 15 forwardly extended from the front side of the head 12 of the housing 10, and a nail magazine 16 connected between the barrel 15 and the rear end of the handle 13.

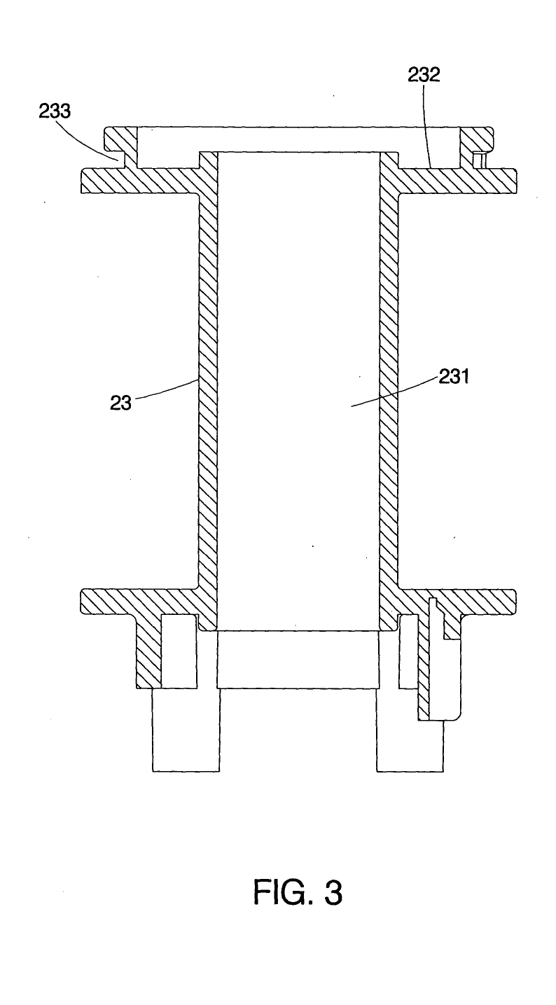

The nail driving mechanism 20 is mounted in the receiving chamber 14 inside the housing 10, comprised of a plunger 21, a driving tip 22, a coil holder 23, a coil 24, spring means, for example, a conical spring 25, and a cushion 26. The plunger 21 is a cylindrical iron core having a top screw hole 211 in the top end. The driving tip 22 is fixedly fastened to the bottom end of the plunger 21. The coil holder 23 has an axially extended center through hole 231, which receives the plunger 21. The coil 24 is mounted on the periphery of the coil holder 23. When electricity connected to the coil 24, the coil 24 is energized, and therefore the iron core, namely, the plunger 21 is forced to move axially along the center through hole 231 of the coil holder 23. Referring also to FIG. 3, the coil holder 23 has a plurality of raised female retaining portions 233 and outwardly downwardly sloping guide faces 234 alternatively arranged in the top wall 232 around the center through hole 231. The conical spring 25 is sleeved onto the plunger 21 and supported on the top wall 232 of the coil holder 23. The cushion 26 is located on the bottom side of the coil holder 23 around the center through hole 231.

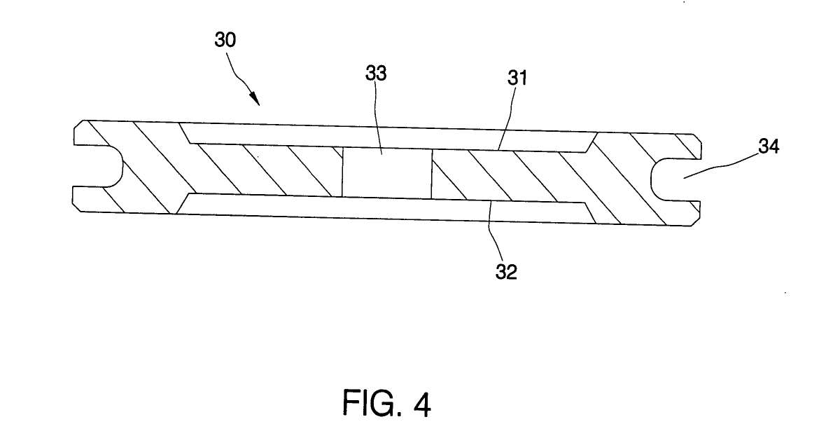

The piston head is comprised of the disk member 30 and the friction ring 40. The disk member 30 has a diameter greater than the plunger 21. Referring also to FIG. 4, the disk member 30 has a center through hole 33 cut through the top surface 31 and the bottom surface 32, and a locating groove 34 extended around the periphery. A screw rod 35 is inserted through the center through hole 33 and threaded into the top screw hole 211 of the plunger 21 to fixedly secure the disk member 30 to the top end of the plunger 21. The piston head, which comprises the disk member 30 and the friction ring 40, and the plunger 21, which serves as a piston rod, form a piston movable in the cylinder 50.

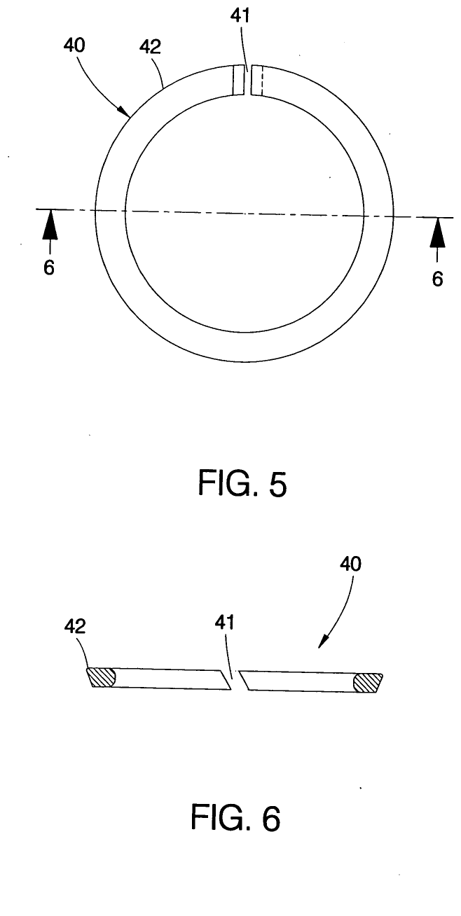

The friction ring 40 is made of wear resistant material, for example, Teflon. Referring also to FIGS. 5 and 6, the friction ring 40 is a split ring having a bevel split 41 and an outer peripheral wall 42. The friction ring 40 is fastened to the locating groove 34 of the disk member 30.

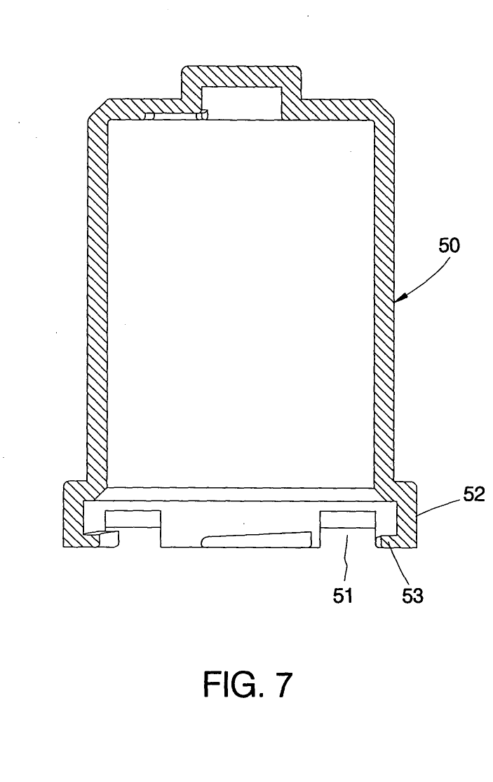

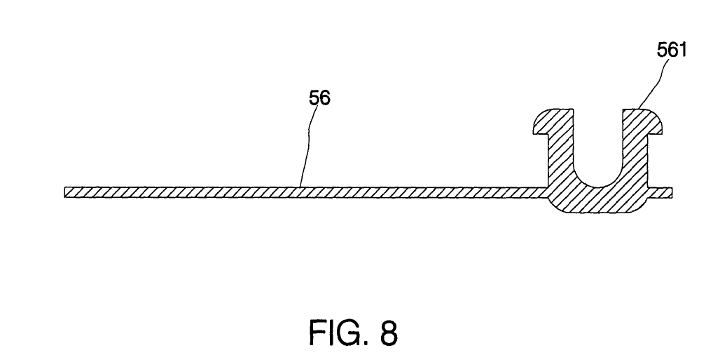

The cylinder 50 is shaped like a cap having a top close end, a bottom open end and an inside receiving chamber. Referring also to FIG. 7, the cylinder 50 comprises a plurality of bottom notches 51 and bottom protruding blocks 52 equiangularly and alternatively arranged around the bottom open side, a plurality of male retaining portions 53 respectively inwardly projecting from the bottom protruding blocks 52, a top mounting hole 51 in the top wall, a top through hole 55 through the top wall, and a deformable valve flap 56 mounted on the inside and adapted to close the through hole 55. Referring also to FIG. 8, the valve flap 56 has a plug 561 disposed at one end and fastened to the mounting hole 54 such that the body of the valve flap 56 covers and closes the through hole 55.

When loading the cylinder 50, attach the cylinder 50 to the top wall 231 of the coil holder 23 to aim the bottom protruding blocks 52 at the guide faces 234 of the coil holder 23 respectively, and then rotate the cylinder 50 relative to the coil holder 23 to the position where the bottom notches 51 of the cylinder 50 are respectively aimed at the guide faces 234, forming an exhaust port A. At this time, the male retaining portions 53 of the cylinder 50 are respectively engaged into the female retaining portions 233 of the coil holder 23, keeping the outer peripheral wall 42 of the friction ring 40 is slight contact with the inside wall of the receiving chamber of the cylinder 50.

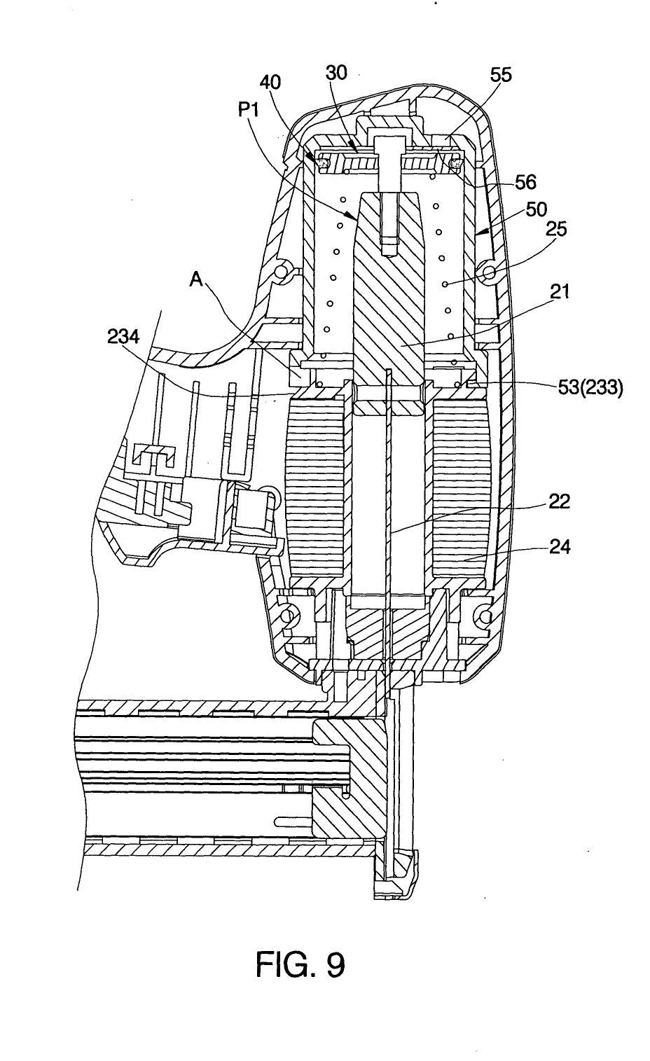

The above statement describes the structure of the electric nailing gun 1. FIG. 9 shows the status of the electric nailing gun 1 before action. At this time, the plunger 21 is in the standby position P1, the conical spring 25 is fully extended and supports the disk member 30 at the top side inside the cylinder 50, and the valve flap 56 closes the through hole 55.

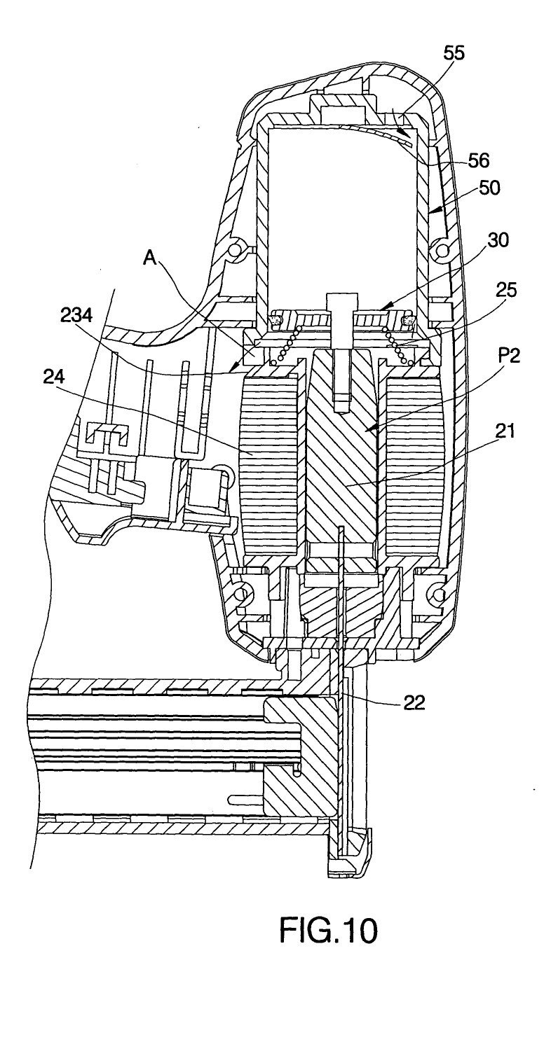

Referring to FIG. 10, when electricity connected to the coil 24, the coil 24 is energized to produce a magnetic field, thereby causing the plunger 21 to move downwards rapidly, and the driving tip 22 is moved toward the nailing position P2. During down stroke of the plunger 21, air outside the cylinder 50 passes downwards to move the valve flap 56 away from the through hole 55 and to enter the receiving chamber of the cylinder 50, and at the same time air inside the receiving chamber of the cylinder 50 below the disk member 30 is squeezed out of the cylinder 50 through the exhaust port A and guided outwards by the guide faces 234 toward the coil 24 to carry heat away from the coil 24. After the nail driving action, the conical spring 25 pushes the plunger 21 back to the standby position P1 (see FIG. 9), thereby causing the valve flap 56 to close the through hole 55 again. At this time, the air inside the receiving chamber of the cylinder 50 above the disk member 30 is compressed, buffering the return speed of the plunger 21.

As indicated above, the invention control air intake and exhaust volume to buffer the return stroke of the plunger 21 from the nailing position P2 to the standby position P1 without affecting the nail driving action, eliminating the drawback of the prior art design of impact between parts. Further, during air flow exchange between intake and exhaust, exhaust air carries heat away from the coil 24, lowering the inside temperature of the housing 10. Therefore, the invention is an innovative design having an industrial value.

The aforesaid disk member 30 and friction ring 40 form a piston head movable in the cylinder 50. As a substitute, the piston head can be directly formed of a round block of wear resistant material peripherally disposed in slight contact with the inside wall of the cylinder 50. Further, the housing 10 can be made to provide directly a receiving chamber for the reciprocating motion of the piston to substitute for the cylinder 50.

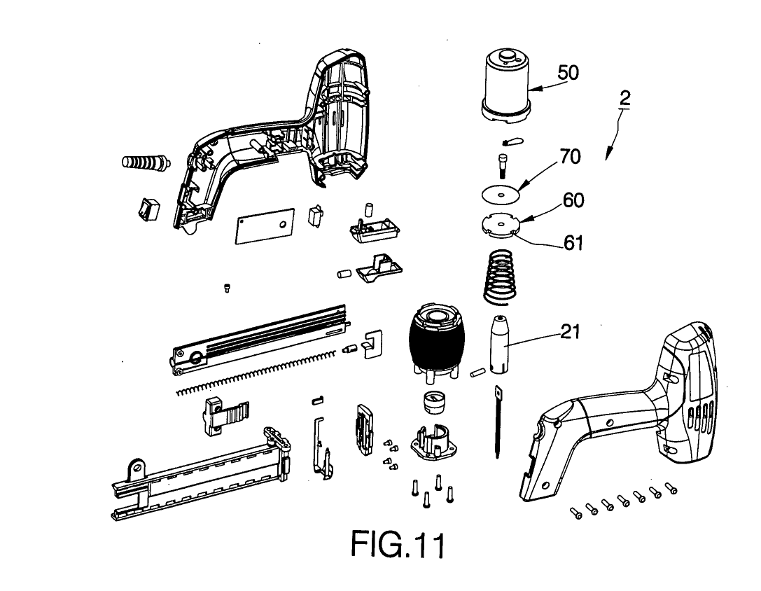

FIG. 11 shows an electric nailing gun 2 according to the second preferred embodiment of the present invention. The electric nailing gun 2 according to this embodiment is substantially similar to the aforesaid first embodiment of the present invention with the exception of the features outlined hereinafter.

The top end of the plunger 21 is directly fixedly mounted with a disk member 60 and a deformable circular gasket 70. The disk member 60 has an outer diameter not greater than the diameter of the receiving chamber of the cylinder 50, and a plurality of peripheral notches 61 arranged around the periphery. The diameter of the gasket 70 is approximately equal to the disk member 60. When the electric nailing gun 2 does no work, the gasket 70 is closely attached to the top side of the disk member 60 to block the periphery notches 61. During down stroke of the plunger 21, a part of air passes upwards through the peripheral notches 61 to lift the peripheral area of the gasket 70, and a part of air is forced downwardly outwards by the disk member 60, achieving the same heat dissipating effect. Further, during return stroke of the plunger 21, the gasket 70 blocks the peripheral notches 61 again to buffer the returning speed of the plunger 21. Therefore, the electric nailing gun 2 achieves the same effect and function as the aforesaid first embodiment of the present invention.

1. An electric nailing gun comprising:
a housing provided with a receiving chamber;
a barrel located on a front side of said housing;
a nail magazine connected between said barrel and said housing;
a nail driving mechanism mounted inside said housing and having a fixed coil holder provided with an axially extended center through hole, a plunger slidably mounted in the axially extended center through hole of said coil holder and movable between a standby position and a nailing position, spring means supporting said plunger in said standby position, and a coil wound round said coil holder and adapted to cause said plunger to move from said standby position to said nailing position when electrically connected; and
a piston head located on a top side of said plunger for synchronous motion, said piston head having an outer diameter smaller than a diameter of said receiving chamber of said housing and greater than an outer diameter of said plunger, said piston head being adapted to force air below toward said coil during a forward stroke of said plunger from said standby position to said nailing position, and to compress air above and to further buffer returning speed of said plunger during a return stroke of said plunger from said nailing position to said standby position.

2. The electric nailing gun as claimed in claim 1, further comprising a cylinder installed inside said housing and having said receiving chamber for accommodating said piston head, said cylinder having a bottom open end fastened to a top side of said coil holder to form at least one exhaust hole for guiding air out of said receiving chamber of the cylinder toward said coil; said piston head comprises a disk member having an outer diameter not greater than the diameter of said receiving chamber of the cylinder; said spring means is supported between a bottom side of said disk member and the top side of said coil holder.

3. The electric nailing gun as claimed in claim 2, wherein said cylinder has a top close end provided with a top through hole, and a deformable valve flap fastened to a wall of the receiving chamber to close said top through hole.

4. The electric nailing gun as claimed in claim 3, wherein said cylinder comprises a plurality of bottom notches and bottom protruding blocks equiangularly and alternatively arranged around the bottom open side, and a plurality of male retaining portions respectively inwardly projecting from said bottom protruding blocks; said coil holder comprises a plurality of top female retaining portions respectively engaged with the male retaining portions of said cylinder to secure said cylinder to said coil holder, enabling the bottom notches of said cylinder to form a plurality of said exhaust holes for exhaust of air out of said receiving chamber of the cylinder toward said coil.

5. The electric nailing gun as claimed in claim 4, wherein said cylinder further comprises a plurality of outwardly downwardly sloping guide faces spaced from one another by said top female retaining portions and adapted to guide exhaust air from said exhaust holes toward said coil.

6. The electric nailing gun as claimed in claim 5, wherein said piston head comprises said disk member having a locating groove extended around a periphery thereof, and a friction ring fastened to the locating groove around the periphery of said disk member and disposed in contact with the wall of said receiving chamber of the cylinder.
